(19) United States
(12) Patent Application Publication
(10) Pub. No.: US 2010/0293188 A1
(43) Pub. Date: Nov. 18, 2010

(54) METHOD FOR REDUCING THE WORKLOAD OF SERVERS, CORRESPONDING TERMINAL, DEVICE AND COMPUTER SOFTWARE PRODUCT

(75) Inventor: Christian Bertin, Rennes (FR)

Correspondence Address: WESTMAN CHAMPLIN & KELLY, P.A., SUITE 1400, 900 SECOND AVENUE SOUTH, MINNEAPOLIS, MN, 55402, US

(73) Assignee: FRANCE TELECOM, Paris (FR)

(21) Appl. No.: 12/680,695

(22) PCT Filed: Sep. 26, 2008
(86) PCT No.: PCT/FR08/51731

§ 371 Date: Jun. 7, 2010

(30) Foreign Application Priority Data
Sep. 28, 2007 (FR) 0757946

(51) Int. Cl. G06F 17/30

(52) U.S. Cl. 707/769; 707/E17.014

(57) ABSTRACT

A method is provided for generating a query request to be transmitted to at least one receiving entity in a communication network. The method includes: receiving a developed and previously formulated query request; selecting a synthetic form adapted to the developed query request from a set of pre-established synthetic forms; and constructing a synthetic query request from the selected synthetic form, wherein the synthetic query request is to be transmitted to the receiving entity.

### CROSS-REFERENCE TO RELATED APPLICATIONS

This Application is a Section 371 National Stage Application of International Application No. PCT/FR2008/051731, filed Sep. 26, 2008 and published as WO 2009/050391 on Apr. 23, 2009, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The present disclosure pertains to the field of telecommunications.

The present disclosure pertains more particularly to the reduction of processing workloads dictated on certain apparatuses of telecommunications networks.

Indeed, one of the direct effects of the constant growth in the number of persons connected at high bit-rates, especially through ADSL offers, is a great increase in the number of demands made on servers responsible for rendering services to the users.

Such demands are made especially in fields such as interactive services, proposed especially through television or video-on-demand offers. These offers are also present to a great extent in telephony services, especially telephony-on-IP services, implemented for example by means of IMS architectures.

The major demands made on servers have two consequences in particular:
a necessary increase in the sizes of the servers, in terms especially of processing and storage capacities;
an intermittent impossibility of implementing the services requested by the users.

Thus, for example, in the field of interactive television services, servers are used to provide information on request about the programs broadcast. These servers are responsible for receiving query requests from terminals implemented by users and for responding to these queries.

### BACKGROUND OF THE DISCLOSURE

In the case of interactive television services such as the one referred to here above, it is not possible to know the contents of the users' queries in advance. Indeed, the possibilities of querying that are offered to the user are vast. One example of an information service of this kind is that of program guides (electronic program guides) known as “TV-Anytime”. These services are based on the use of protocols to request program information on a central site. The “TV-Anytime” service uses a protocol which has been standardized under the reference “TS 102822-6-1”.

For example, a user can use his terminal to ask for:

the title of a content currently broadcast on a particular channel;

the time at which the following program starts on another particular channel.

It regularly happens that servers receive a burst of several queries from the terminals. Generally, these queries “in bursts” arrive simultaneously and correspond to prime times or to advertisement breaks for example. They cause workload peaks at the servers because of the simultaneous reaction of the users watching a big-audience channel. The users all interact together at precise points in time: at half-time during a match, or at the start of the advertisement.

In addition, it may happen that these queries are identical. That is, the user of a terminal A will formulate the same request as the user of a terminal B. These two queries will be processed identically by the server as if they were two different queries.

In order to reduce the workload of the servers in improving the above solution, it is assumed that server is likely to receive numerous identical queries.

This server therefore records the responses in a database, thus preventing it from having to rebuild a response identical to the one it has just built. This however does not prevent it from having to re-analyze the totality of the next request before ascertaining that an adequate response exists.

### SUMMARY

The approach proposed by an exemplary embodiment of the invention does not have these drawbacks of the prior art. The approach indeed pertains to a method for generating a query request designed to be transmitted to at least one receiving entity of a communications network. According to an embodiment of the invention, such a method comprises:
a step for receiving a pre-formulated, expanded query request;
a step for selecting a synthesis form adapted to said expanded query request from amongst a set of pre-established synthesis forms;
a step for building a synthesis query request from said selected synthesis form, said synthesis query request being designed to be transmitted to the receiving entity.

Thus, an embodiment of the invention can be used to formulate a synthesis query request that is not as bulky as the expanded query request. The synthesis query request is not a compression of the expanded query request but a different form of formulating this request. The result of this is a drastic fall in the workload of the entity that receives the synthesis query request. The synthesis query request can also be called a “shortened” request inasmuch as it is shorter than the expanded query request. It indeed represents the same piece of information as the expanded query request but in a reduced way. In other words, the size of the synthesis query request is diminished without there being any compression of this request, but, by the establishment of a correspondence between the expanded query request and the synthesis query request. Synthesis forms of queries are preliminarily available. When an expanded query request has to be formulated, an embodiment of the invention makes it possible to check for the existence of a correspondence between the expanded query request and a form of synthesizing this request. Thus, if there is a synthesis form in existence, a synthesis query request is built. If not, the expanded form is built and transmitted.

According to one particular embodiment of the invention, said synthesis query request is encapsulated in said expanded query request prior to the transmission of said synthesis query request.

Thus, an embodiment of the invention can be used to provide for total compatibility with existing apparatuses. Indeed, an embodiment of the invention reduces the workload of the servers by means of synthesis query requests. It is nevertheless necessary to make sure that such synthesis query requests do not disturb the conventional working of the prior art devices which would be incapable of taking full advantage of an embodiment of the invention. To this end, the synthesis query requests are ingeniously encapsulated in the expanded query request. Such an implementation ensures compatibility of the method of an embodiment of the invention with the existing technologies for processing queries. This encapsulation is done so as not to disturb intermediate apparatuses.

According to one particular characteristic of an embodiment of the invention, the synthesis query request is built out of said selected synthesis form and at least one query parameter specified in said expanded query request.

An embodiment of the invention also pertains to a method for processing a synthesis query request built out of a synthesis form corresponding to an expanded query request.

According to an embodiment of the invention, such a method comprises a step of searching, from said synthesis query request, for a response to said synthesis query request from amongst a set of available responses associated with query requests.

Thus, an embodiment of the invention can be used to take account of similar or identical queries which have already been the object of a response. Indeed, rather than overloading the entity with identical processing operations, the synthesis query request is compared, during the search, with other prior synthesis query requests received by the entity. If a response to this synthesis request can be identified, then this response is obtained. If this is not the case, the response is built by the entity.

Thus, the method of an embodiment of the invention substantially reduces the workload of the entities of the communications network and especially that of the receiving entity by swiftly identifying, on the basis of the synthesis query request, a response built prior to this request.

According to one particular embodiment of the invention, said processing method comprises, when said request has not been found from the synthesis request from amongst the set of available responses:

a step for building said response, and;

a step for storing said response in said set of available responses.

Thus, an embodiment of the invention further reduces the time taken to process the request when it reaches the receiving entity. Indeed, the receiving entity which implements the method of an embodiment of the invention swiftly identifies a synthesis query request and is capable of searching for a response to this request without it's being necessary to “decode” an expanded query request that is more complex than the synthesis query request. The time taken to process the synthesis query request is therefore smaller than that of the initial request, thus improving the performance of the server and therefore the performance of the system in its totality.

According to one particular characteristic of an embodiment of the invention, said processing method comprises, subsequently to said building step, a step for time-stamping said stored request defining a date of expiry of said response.

An embodiment of the invention therefore averts the possibility of giving any response whatsoever to a synthesis query request but makes it possible to provide a response that is not out of date. Indeed, since the queries are synthesized, it can happen for example that a same synthesis query request will not lead to the provision of the same response depending for example on the time at which the synthesis query request has been formulated. Thus, a synthesis query request aimed at obtaining the name of the program being broadcast on channel 1 will not obtain the same response if it is sent at 18.00 hours on the one hand and at 22.00 hours on the other hand. An embodiment of the invention therefore overcomes this constraint by making a comparison, during the search for a pre-built response, between the date of the synthesis query request and the date of expiry of the pre-built response.

According to one particular embodiment of the invention, said processing method comprises a step, when said response has not been found from the synthesis query request amongst said set of available responses, for transmitting the synthesis query request to a receiving entity.

According to one particular characteristic of an embodiment of the invention, said processing method comprises:
a step for receiving said response to said synthesis query request, coming from said receiving entity;
a step for storing said response to said query request in said set of available responses.

Thus, an embodiment of the invention ensures that the occurrence of an synthesis query request identical to the one saved by the intercepting entity will not prompt the transmission of this request to the receiving entity. This synthesis query request for which the intercepting entity has a response will therefore not increase the workload of the receiving entity.

An embodiment of the invention also pertains to a sender entity sending a query request designed to be transmitted to at least one receiving entity of a communications network. According to an embodiment of the invention, such an entity comprises:
means for receiving a pre-formulated, expanded query request;
means for selecting a synthesis form adapted to said expanded query request from amongst a set of pre-established synthesis forms;
means for building a synthesis query request from said selected synthesis form, said synthesis query request being designed to be transmitted to the receiving entity.

In one particular embodiment of the invention, such an entity may for example take the form of a communications terminal such as an IP/TV terminal.

An embodiment of the invention also pertains to a receiving entity for receiving a synthesis query request built out of a synthesis form corresponding to an expanded query request. According to an embodiment of the invention, such an entity comprises:
means of searching, from said synthesis query request, for a response to said synthesis query request from amongst a set of available responses associated with query requests.
means for building said response, and;
means for storing said response in said set of available responses.

In one particular embodiment of the invention, such a receiving entity may be an application server in charge of supplying a service. For example, it may be an IP/TV server complying with the <<TV Anytime>> standard.

An embodiment of the invention also pertains to an intercepting entity for intercepting a synthesis query request built out of a synthesis form corresponding to an expanded query request. According to an embodiment of the invention, such an entity comprises
means of searching, from said synthesis query request, for a response to said synthesis query request from amongst a set of available responses associated with query requests.
means for transmitting the synthesis query request to a receiving entity;
means for receiving said response to said synthesis query request, coming from said receiving entity;
means for storing said response to said query request in said set of available responses.

In one particular embodiment of the invention, such an intercepting entity can take the form of a router of said communications network. In another embodiment of the invention, such an entity can take the form of a DSLAM, an apparatus responsible for linking the communications terminal to the IP network of a telecommunications operator.

In this embodiment, the means implemented can be used to ascertain that the intercepting entity has a response to the request transmitted. If this is so, the intercepting entity is capable of giving the expected response to the request-sending entity. In this embodiment of the invention, the recognition by the intercepting entity has a bearing on the synthesis query request. It is quite clear to those skilled in the art that a recognition of this kind can also pertain to the initial non-synthesized request. The recognition of the synthesis query request nevertheless removes the need for high processing power. Indeed, since the synthesis query request can be seen as a “shortened” form of the expanded query request, it consumes fewer resources for recognizing a synthesis query request than an expanded query request since the synthesis query request is shorter.

An embodiment of the invention also pertains to a processing system. According to an embodiment of the invention, such a system comprises:
a sending entity sending a synthesis query request designed to be transmitted to at least one receiving entity of a communications network, comprising:
   means for receiving a pre-formulated, expanded query request;
   means for selecting a synthesis form adapted to said expanded query request from amongst a set of pre-established synthesis forms;
   means for building a synthesis query request from said selected synthesis form, said synthesis query request being designed to be transmitted to the receiving entity; and
a receiving entity for receiving a synthesis query request built out of a synthesis form corresponding to an expanded query request, comprising:
   means of searching, from said synthesis query request, for a response to said synthesis query request from amongst a set of available responses associated with query requests;
   means for building said response, and;
   means for storing said response in said set of available responses.

According to an original embodiment of the invention, said processing system furthermore comprises:
at least one intercepting entity for intercepting a synthesis query request built out of a systnesis form corresponding to an expanded query request comprising:
   means of searching, from said synthesis query request, for a response to said synthesis query request from amongst a set of available responses associated with query requests;
   means for transmitting the synthesis query request to a receiving entity;
   means for receiving said response to said synthesis query request, coming from said receiving entity;
   means for storing said response to said query request in said set of available responses.

According to another aspect, an embodiment of the invention also pertains to a computer software product downloadable from a communications network and/or recorded on a computer-readable carrier and/or executable by a microprocessor, and comprising program code instructions for executing the method for generating as described here above

According to another aspect, an embodiment of the invention also pertains to a computer software product downloadable from a communications network and/or recorded on a computer-readable carrier and/or executable by a microprocessor and comprising program code instructions for executing the method for processing as described here above.

### BRIEF DESCRIPTION OF THE DRAWINGS

Other features and advantages shall appear more clearly in the following description of a preferred embodiment given by way of a simple illustratory and non-exhaustive example, and from the appended drawings, of which:

FIG. 1 is a block diagram illustrating the principle of a synthesis query request;

FIG. 2 is a block diagram presenting the principle of request interception;

FIG. 3 describes an example of an architecture for a mode of implementation of an embodiment of the invention;

FIG. 4 describes a sequence of actions leading to a response to a non-intercepted synthesis query request in the architecture of FIG. 3;

FIG. 5 describes a sequence of actions leading to a response to a synthesis query request intercepted in the architecture of FIG. 3;

FIGS. 6, 7 and 8 briefly describe the hardware architectures of the entities for implementing the method of an embodiment of the invention.

### DETAILED DESCRIPTION OF ILLUSTRATIVE EMBODIMENTS

### 1. Reminder of the Principle of an Embodiment of the Invention

An embodiment of the invention can be used to reduce the processing workloads of the entities that receive multiple query requests. Such entities may be for example servers providing information on program guides. An embodiment of the invention however is not limited solely to these information servers but is more generally applicable to any type of entity receiving complex query requests. Such queries are for example built in the form of a data structure requiring substantial processing resources on the part of the entity.

Indeed, the markup language XML is powerful since it can be used to describe data in an open and structured manner. Two identical queries can be written in very different ways, making the recognition of a reply very costly in machine time. However, this method has a major drawback: the entities (servers, customers, database managers etc) responsible for implementing it must possess substantial computation resources only to enable a building of the memory data structure. Now, while such resources are generally available for processing a few files, it becomes more difficult to obtain these resources when a server entity for example has to process several thousands of queries simultaneously.

It is therefore always necessary to increase the sizing of these server entities in order to respond to demands. An embodiment of the invention enables the reduction of the workload of the entities and prevents the need to multiply the allocated resources. An embodiment of the invention comprises two different aspects:
the synthesizing of the queries, enabling the creation of a shortened form of a request sent to an entity. This shortened form, because of its compactness, requires no substantial resources to be identified and thus reduces the workload of the receiving entity.
the intercepting of queries, which is a mechanism by which an intermediate entity can benefit from the communications network, responsible for example for routing this communications network, analyzing the request and checking to see if it does not already have a response to this request.

These two different mechanisms, ingeniously implemented by the inventors, can be combined in certain preferred embodiments to obtain an even greater diminishing of the workloads of the entities for processing query requests.

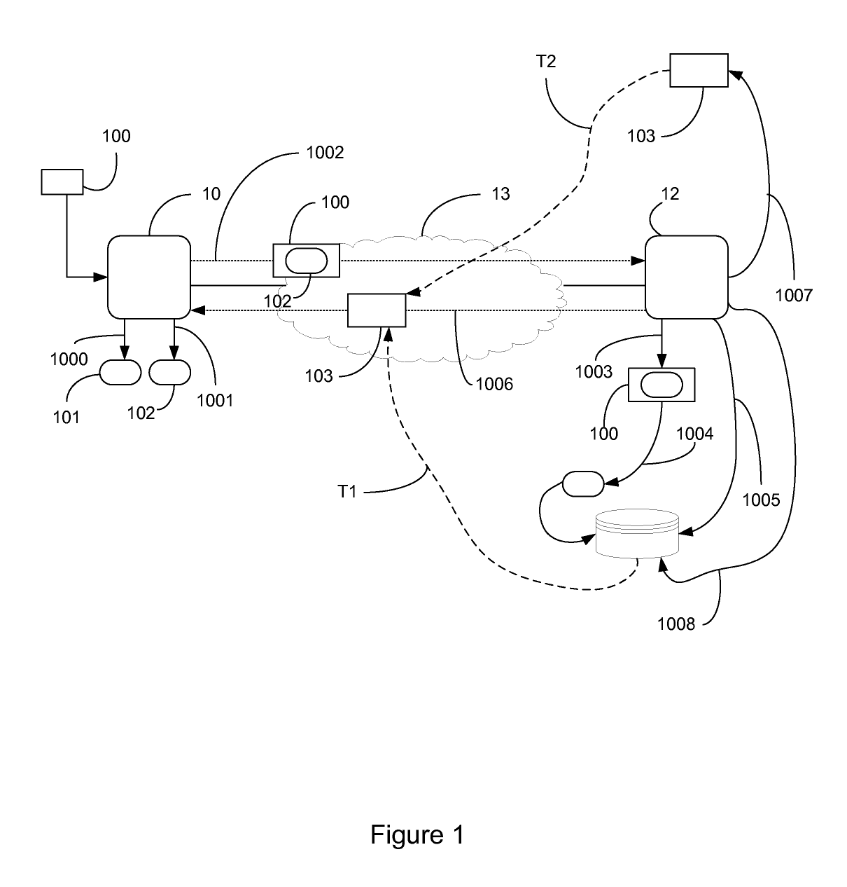

Referring now to FIG. 1, we present a block diagram providing a synthesis explanation of the general working of the synthesizing of queries according to an embodiment of the invention.

A sender entity 10 wishes to obtain a response to an expanded query request 100, pre-formulated either by an entity dedicated to this purpose or by the sender entity 10 itself. The sender entity 10 is connected to a communications network. Prior to the sending of the expanded query request 100, the sender entity ascertains (1000) the presence of a synthesis form 101 of the query request to be sent. If such a form is present, it builds (1001) a synthesis query request 102 on the basis of the synthesis form 101 and the expanded query request 100. This synthesis query request 102 is then inserted into the expanded query request 100. The expanded query request (which therefore contains the synthesis query request 102) is transmitted (1002) to the receiving entity.

The receiving entity 12 receives (1003) the expanded query request and identifies (1004) the presence of the synthesis query request 102. The receiving entity 12 then proceeds in two stages (T1 and T2), on the basis of the synthesis query request 102 (and not on the voluminous expanded query request 100):
T1: it searches (1005) for a preliminarily built response to the synthesis query request 102, a response (103) which it then sends (1006) to the sender entity if it finds it;
T2: it builds (1007) a response to the synthesis query request 102, a response 103 which it then sends (1006) to the sender entity if it finds it after it has saved (1008) it for a possible subsequent use.

Thus, the synthesizing of queries according to an embodiment of the invention reduces the workload of the receiving entity in two stages: firstly by reducing the time taken to analyze the request since it is not the expanded query request that is analyzed as such but only the synthesis query request, and secondly by enabling a search for a pre-built response corresponding to the synthesis query request (and not the expanded query request).

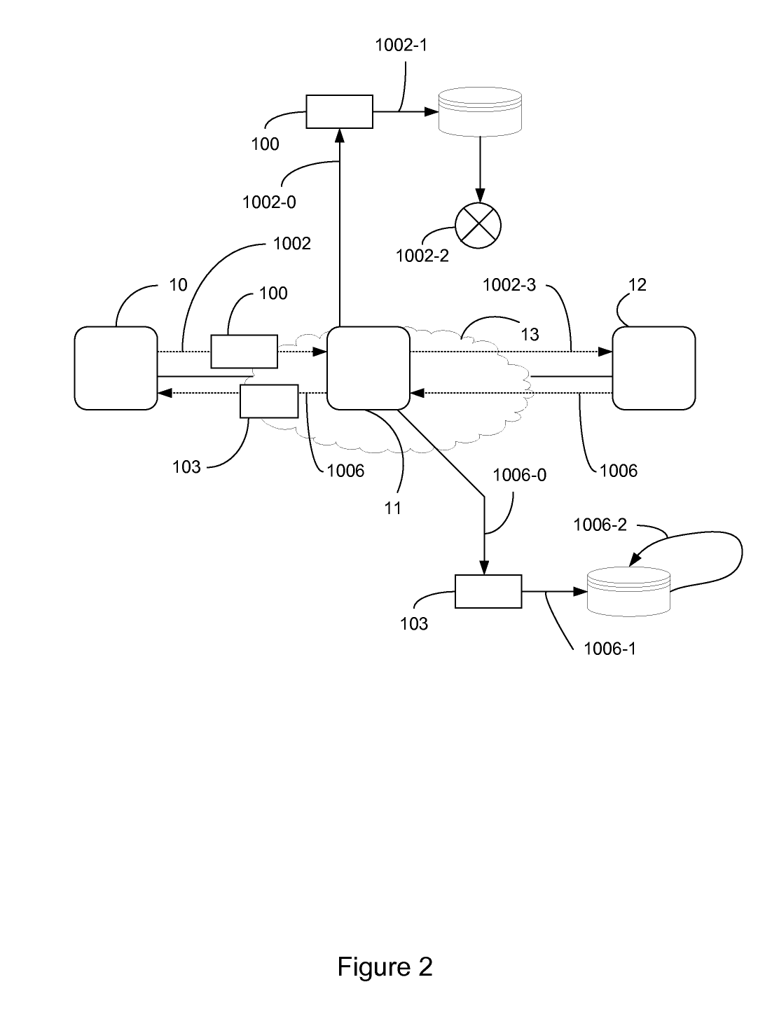

Referring now to FIG. 2, we present a block diagram providing a synthesis explanation of the general working of the interception of queries according to an embodiment of the invention (the references of FIG. 1 have been kept for greater facility).

A sender entity 10 wishes to obtain a response to an expanded query request 100. The sender entity 10 is connected to a communications network. It transmits (1002) the expanded query request 100 to the receiving entity 12. An intermediate entity 11 such as a router, a DSLAM, or another entity of the communications network (such as a local or regional server) through which the expanded query request 100 travels in transit, intercepts (1002-0) the expanded query request and proceeds in two stages:
it searches (1002-1) for a pre-built response to the expanded query request 100, a response (103) which it then sends (1006) to the sender entity if it finds it. It then interrupts (1002-2) the transfer of the expanded query request 100.
it transfers (1002-3) the expanded query request 100 to the receiving entity 12 if it does not have any response to this expanded query request 100.
During the passage (1006) of the response to the expanded query request 100, the intercepting entity 11 examines (1006-0) this response and checks (1006-1) to see if it is not already present in a response preservation zone. If this is not the case, this response 103 is kept (1006-2) in the memory of the intercepting entity 11 for possible subsequent use.

Clearly, an interception sequence can be formed and it is not compulsory to carry out only one interception so that if the next routing entity can find a pre-recorded response to the expanded query request, it implements the same mechanism as the initial interception entity. This principle is also valid for the responses. An embodiment of the invention thus makes it possile to build a pyramidal architecture of distribution of query requests and responses to the receiving entity which is situated at the last step of the pyramid.

The inventors have also ingeniously combined the two principles presented here above. Through this combination it is possible:
to neither modify nor know the standards taken into account by the intermediate apparatuses, by inserting the synthesis query request within the expanded query request;
to be able to make the combined invention work on intermediate entities possessing low computation power without databases indispensable to generating responses by analyzing only the synthesis query requests within these databases and not the bulkier expanded query requests;
using the resources for saving different entities of the communications network efficiently in order to provide the information expected by the sender apparatus as quickly as possible.

The invention is in no way restricted to this concise presentation in which the sender entity is also the one that searches for a correspondence with a synthesis form of the request. Such an implementation assumes specific resources on the part of this sender entity. It is clear that it possible that such resources will not be available and that an intermediate apparatus of the communications network will fulfill this correspondence search function instead of the sender entity.

Here below, we present especially the case of an implementation of the mechanisms of an embodiment of the invention applied to the XML queries protocol defined and standardized by the “TV Anytime” forum. It is clear however that the invention is not limited to this special form of implementation but can also be applied in many other fields especially those of query protocols using the XML language as a query defining medium and more generally in all cases where the advantages of embodiments of the invention are promising.

### 2. General Description of One Embodiment

In this embodiment, we present the implementation of the mechanisms of the invention with architectures defined by the “TV Anytime” forum. This forum has standardized an XML request protocol, referenced TS 102 822-6-1 to request a metadata server for information on one or more contents or on one or more channels. In this mode of implementation, the IP protocol is used as a transportation protocol. The applications protocol is the HTTP protocol. The data encapsulation protocol is SOAP. It enables the XML query requests to be conveyed from the sender entity to the receiving entity.

In this embodiment of the invention, the sender entities are terminals, for example TV program viewing terminals using the IP protocol. The intercepting entities, which are intermediate interception apparatuses, are routers responsible for routing the query requests sent out by the terminals to the receiving entity which in this embodiment is the program guide information server.

Briefly, this implementation of method of an embodiment of the invention comprises the following phases:
The terminals send query requests pertaining to the most common program information elements not in the expanded form of the queries but in the synthesis form;
The intermediate apparatuses, which receive the synthesis query requests, make a search to see if this request is not present in their list of already received synthesis query requests.
   If the request has already been received and if the duration of the validity of the response has not elapsed, then the intermediate apparatus responds immediately to the terminal by sending the stored response;
   If the synthesis query request has not yet been received it is stored in the intermediate apparatus and transmitted to the central terminal.
The central server makes the same search on the synthesis query request and, if it has not already received it, it will process it in extracting requested program information from the database and will prepare the response which it will store locally (in a unit for obtaining pre-constructed responses, for example a database) with a copy of the synthesis query request received (with duration of validity).
   In one complementary embodiment of the invention, the central server, upon reception of an expanded query request in the classic XML format, builds the corresponding synthesis query request and stores its result to enable the speeder and less costly (in terms of transmit time) broadcasting of its result during a subsequent search.
Upon the response from the central server, the intermediate apparatus stores the response and retransmits the response to the terminal with its duration of validity.

In this embodiment, only the synthesis query requests are analyzed by the intermediate apparatuses. Indeed, they possess no databases to process commands in the classic XML format nor knowledge of the XML query protocol (request and response).

More particularly, essential technical elements of this embodiment are the following:
Defining a command code for each of the most frequent queries;
Defining a strict syntax for the encoding of the command codes as well as parameters of these commands to enable fast recognition of a command both by the central server and by possible intermediate apparatuses;
Defining a code in the responses to signal the fact that it is the response to a synthesis query request;
Positioning the indication of a response to a synthesis question as well as its duration of validity at a search point that is speedily accessible without having to understand the syntax of the responses.

### 3. Detailed Description of One Embodiment

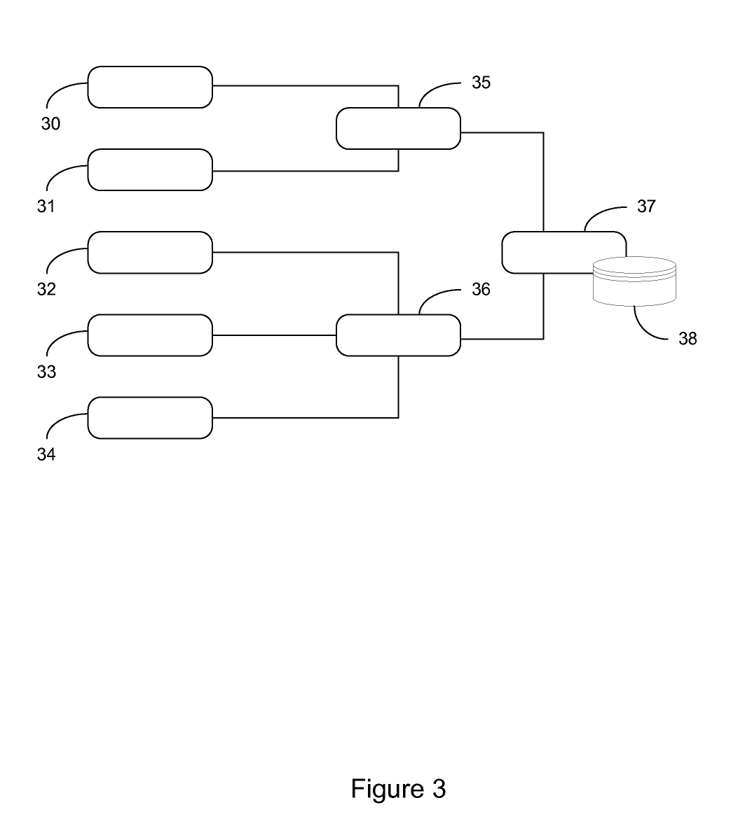

Referring to FIG. 3, we present the general configuration of the implementation of an embodiment of the invention.

Five sender entities (receiver entities) 30, 31, 32, 33 and 34 are connected to two local routers or servers (intercepting entities) 35 and 36. The receiver terminals 30 and 31 are connected to the router 35 while the terminals 32, 33 and 34 are connected to the router 36.

The two routers 35 and 36 are connected to a central information server of the program guide 37 which has available a means of querying of an information database for programs 38.

Usually, in this type of architecture, the protocol, which is standardized under the reference TS 102 822-6-1, is used to create XML query requests intended for a metadata server to request information on one or more contents, from one or more channels.

Here below, we present an example of a request designed to search for information which contain the word “titanic” in the title:

```
    <?xml version=“1.0” encoding=“UTF-8”?>
    <get_Data xmlns=urn:tva:transport:2005 ...>
      <QueryConstraints>
        <BinaryPredicate fieldID=“tvaf:Title”
fieldValue=“Titanic” test=“contains”/>
      </QueryConstraints>
      <RequestedTables>
        <Table type=“ProgramInformationTable”>
          <SortCriteria fieldID=“tvaf:CRID” order=“ascending”/>
        </Table>
      </RequestedTables>
    </get_Data>
```

We also present another example of a search for information on the programs broadcast on three channels in a two-day time slot:

| | |
|---|---|
| <?xml version=“1.0” encoding=“UTF-8”?> | |
| <get_Data xmlns=urn:tva:transport:2005 ...> | |
| <QueryConstraints> | |
| <PredicateBag type=“AND”> | |
| <BinaryPredicate fieldID=“tvaf:PublishedTime” | |
| fieldValue=“2002-09-26T00:00:00Z” | |
| test=“greater_than_or_equals”/> | |
| <BinaryPredicate fieldID=“tvaf:PublishedTime” | |
| fieldValue=“2002-09-27T23:59:59Z” | |
| test=“less_than_or_equals”/> | |
| <PredicateBag type=“OR”> | |
| <BinaryPredicate | fieldID=“tvaf:ServiceURL” |
| fieldValue=“dvb://1.2.1”/> | |
| <BinaryPredicate | fieldID=“tvaf:ServiceURL” |
| fieldValue=“dvb://1.2.2”/> | |
| <BinaryPredicate | fieldID=“tvaf:ServiceURL” |
| fieldValue=“dvb://1.2.3”/> | |
| </PredicateBag> | |
| </PredicateBag> | |
| </QueryConstraints> | |
| <RequestedTables> | |
| <Table type=“ProgramInformationTable”/> | |
| </RequestedTables> | |
| </get_Data> | |

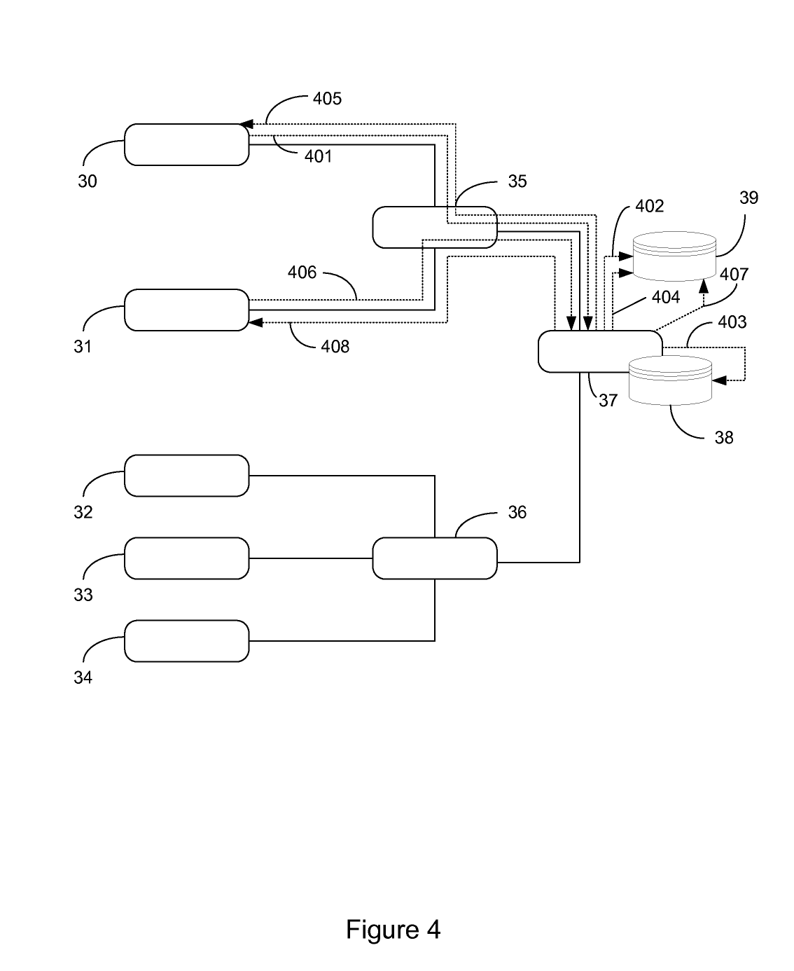

FIG. 4, in which the numerical references of FIG. 3 have been kept, shows a receiver terminal 30 which makes (401) a request to the central server, pertaining to program information 37. This request has not yet been received by another receiver (after a search (402) in a storage database 39 for storing queries and responses, said database 39 being the unit used to obtain pre-built responses in this embodiment of the invention), the central server extracts (403) the information from the database, formats a response and stores it on the server (404) with a maximum duration of validity and sends it back (405) to the receiver 30.

Then, it receives (406) the same synthesis request from the receiver 31, finds (407) the response already ready (in the storage database 39) and this response is immediately transmitted (408) to the receiver 31 without making any search in the database.

In general, the use of XML for the queries is of low efficiency and calls for substantial processing capacities on the part of the apparatuses that use them.

To improve the performances of all the apparatuses that have to process XML queries and responses, this particular embodiment of the invention introduces a “shortening” of these queries or responses into the headers of the XML query requests and responses, which are easy to detect without any impact on the “xsd” scheme defining these queries and responses. This shortened form is therefore a synthesis query request inasmuch as it is shorter than the expanded query request and because it contains all the payload information contained in the original XML request. Here below, we present another embodiment in which the “xsd” scheme for defining these queries and responses will be affected.

In this embodiment, the syntax of this “shortened form” comprises:
Possibly an indication of a request or response scheme if it is sought to be able to intercept several independent XML request protocols
A “string” type synthesis request/response code
Possibly, if the request requires it, a “string” type parameter to enable the acceptance of any parameter whatsoever and even several parameters separated by a delimiter to be chosen.

Thus, the previous expanded query request for searching for contents comprises the word “titanic” in the title and is formed as follows:

```
    <?xml version=“1.0” encoding=“UTF-8”?>
    <!--]a23]124]titanic-->
    <get_Data xmlns=urn:tva:transport:2005 ...>
        <QueryConstraints>
          <BinaryPredicate fieldID=“tvaf:Title”
fieldValue=“Titanic” test=“contains”/>
      </QueryConstraints>
      <RequestedTables>
        <Table type=“ProgramInformationTable”>
          <SortCriteria fieldID=“tvaf:CRID” order=“ascending”/>
        </Table>
      </RequestedTables>
</get_Data>
```

Within this XML request, the synthesis query request is the following:

<!--]a23]124]titanic-->

It corresponds to a synthesis form of the expanded query request in the classic format. It is inserted between two commentary markup tags (the markup tags “<!-->> and <<-->”). This ensures that all the apparatuses incapable of recognizing the particular syntax of the synthesis request query are not put into a state of malfunction.

In other words:
The shortening of the command is inserted as a commentary right at the beginning after the declaration of type of encoding of characters of the request or response (to be located as quickly as possible);
The character “]” or any other marker is inserted at the beginning of a commentary to confirm that it is a shortening of a command;
An XML request code on a character (all the letters in lower case and uppercase without accents and all figures are permitted, giving 62 command codes) is inserted subsequently (in the present example “a” replaces “get_Data”), it replaces the full name of the XML request which is located on the next line;
A scheme code (in the present example “23”) is inserted as the case may be immediately after the request code to distinguish between several request protocols;
A separator is inserted to terminate the scheme code, in this example the figure “]”;
A command code (in the present example “124”) is inserted to replace all the commands detailed here below. The code “124” here indicates a request of all contents having the value of the following parameter in the “title” element. For example, it would be possible to do without any parameter if a command parameter can take only two values, two command codes corresponding to these two possible values of parameters could be created;
A separator is inserted to terminate the command code and separate it from the following element, in this case for example “1”;
A parameter code (in the present example “titanic”), this being doing when the possible values of the parameter are far too numerous to assign them a specific command code corresponding to each of them.

In this embodiment of the invention, the mechanism described applied to the second example here above gives rise to the creation of the following request:

```
    <?xml version=“1.0” encoding=“UTF-8”?>
    <!--]a23]047]dvb://1.2.1&amp;dvb://1.2.2&amp;dvb://1.2.3-->
    <get_Data xmlns=urn:tva:transport:2005 ...>
      <QueryConstraints>
        <PredicateBag type=“AND”>
          <BinaryPredicate fieldID=“tvaf:PublishedTime”
              fieldValue=“2002-09-26T00:00:00Z”
test=“greater_than_or_equals”/>
          <BinaryPredicate fieldID=“tvaf:PublishedTime”
              fieldValue=“2002-09-27T23:59:59Z”
test=“less_than_or_equals”/>
          <PredicateBag type=“OR”>
```

| | |
|---|---|
| <BinaryPredicate | fieldID=“tvaf:ServiceURL” |
| fieldValue=“dvb://1.2.1”/> | |
| <BinaryPredicate | fieldID=“tvaf:ServiceURL” |
| fieldValue=“dvb://1.2.2”/> | |
| <BinaryPredicate | fieldID=“tvaf:ServiceURL” |
| fieldValue=“dvb://1.2.3”/> | |
| </PredicateBag> | |
| </PredicateBag> | |
| </QueryConstraints> | |
| <RequestedTables> | |
| <Table type=“ProgramInformationTable”/> | |
| </RequestedTables> | |
| </get_Data> | |

Where the synthesis query request is the following:

<!--]a23]047]dvb://1.2.1&amp;dvb://1.2.2&amp;dvb://1.2.3-->

The synthesis query request once again is appreciably shorter and more easily identifiable and subdividable than the initial querying command. The command code “047” indicates a request for all the contents broadcast on the current date on the N channels indicated as a parameter. To ensure compatibility with the existing applications which to do not include shortened commands inserted in the commentary inserted at the beginning of the request, the rest of the command will be preserved in its current form.

It is therefore necessary to define a list of command codes corresponding to the most frequent queries.

It will be understood then that the detailed command that follows the shortened command has become unnecessary and could be eliminated, making the command even more compact and therefore less costly in bandwidth and processing time.

<?xml version=“1.0” encoding=“UTF-8”?>
<!--]a23]124]titanic-->

If it is necessary to have several parameters for a synthesis command, a delimiter is chosen that is not used in the syntax of the parameters to be assembled in order to separate them and a precise order is imposed on the parameters to facilitate the recognition of the synthesis commands with several parameters. In this embodiment, it is not necessary to modify the scheme for describing XML responses.

The central server which receives the XML queries recognizes the fact that there is a synthesis query request by its starting marker in the commentary field in the header of the request. It takes the entire commentary and will make a search in the table of available responses to see if this request has already been received and processed.

To this end, it suffices for it to take “a23]124]titanic” (first example) and “a23]047]dvb://1.2.1&amp;dvb://1.2.2&amp;dvb://1.2.3” (second example) as search criteria in the table of responses available having three columns (“shortened XML request”, “response to be sent”, “date of expiry”).

If the request has already been received and processed, the response is ready to be sent. If not, it is necessary to make a search in the meta database to extract the response elements and build the response that the server will store in its table of responses which have already been sent and are associated with synthesis query requests.

The search in the meta database is made on the basis of the synthesis query request. As a variant, the search in the meta database is done on the basis of the expanded query request. The expanded query request used to make the search in the database is the request encapsulating the synthesis query request received by the receiving entity. In one particular embodiment of the invention, the expanded query request used to make a search in the meta database is built in the receiving entity from the synthesis query request.

Here below, we present two types of responses that can be received by the sender entity if it has sent a synthesis query request to search for contents having the word “titanic” in the title. These are:

a) either the response in the usual format

<?xml version=“1.0” encoding=“UTF-8”?>
<get_Data_Result serviceVersion=“1” truncated=“false”>
...
</get_Data_Result>

b) or the next response if the server knows that there are local servers/responders which can recognize the synthesis query request and the responses to these queries.

<?xml version=“1.0” encoding=“UTF-8”?>
<!--}23]124]titanic-->
<!--2007-07-18T18:00-08:00-->
<get_Data_Result serviceVersion=“1” truncated=“false”>
...
</get_Data_Result>

In the commentary in the header of the request, at the very beginning, a marker is inserted indicating that this is a response to an XML request. In the example the character “}” is used as a marker of this type.

<!--}23]124]titanic-->

The rest of the commentary is identical to the synthesis XML query request whose processing has generated this request. An implementation of this kind enables speedy recognition of the expanded query request.

It is not the synthesis of the response that is inserted into the commentary but only a reminder of the XML request that had prompted this response.

It is necessary for the receiving entities and the intercepting entities to indicate the duration of validity of the responses: these are dates and times as of which it is appropriate to destroy this response and let through the first following identical request to obtain a response for which the pieces of data have been updated. This is a method of time-stamping the responses which therefore enable a gradual elimination of the responses that have become unnecessary.

<!--2007-07-18T18:00-08:00-->

This mode of implementing an embodiment of the invention in which the synthesis query request is inserted into a commentary immediately after the markup tag “<?xml>” and before the request itself makes it possible not to disturb the former receivers or other apparatuses for which a modification of the standard is not acceptable. In the case of these old apparatuses, which are unsuited to implementing an embodiment of the invention, the received responses to the queries that they transmit will not contain any shortening of an XML command since they were unable to send XML queries with shortening of queries.

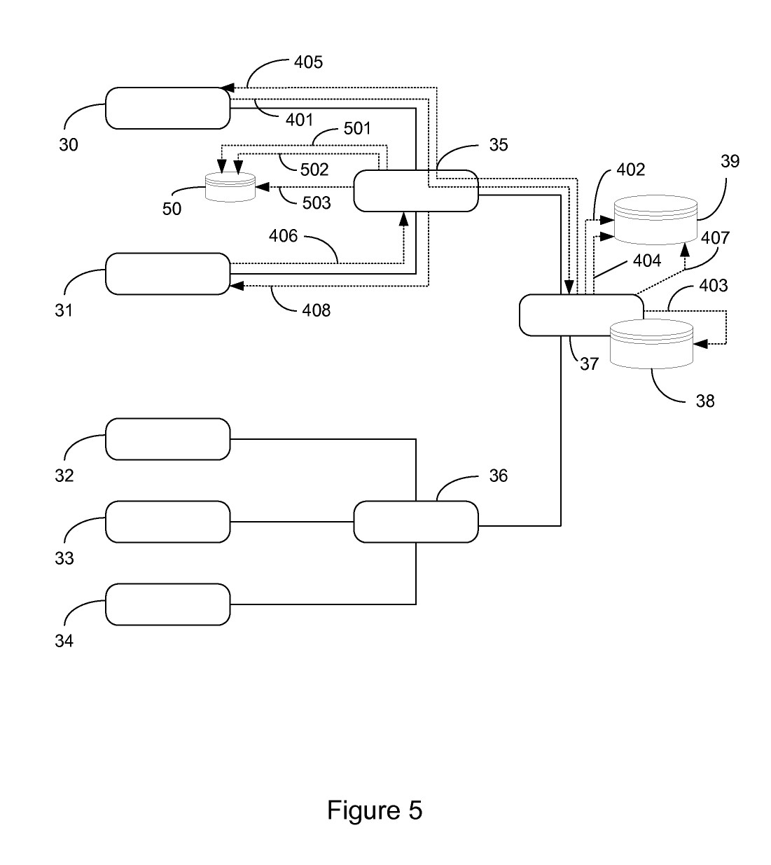

At the same time, and in this embodiment, in combination with this insertion of synthesis query requests into the queries and responses, we obtain synthesis queries and responses that are easy to recognize for intermediate apparatuses, enabling the introduction of local repeaters or services with a minimum of processing to be done according to the following mode of operation described with reference to FIG. 5 in which the references used in FIGS. 3 and 4 have been kept for greater facility.

In FIG. 5, a receiver terminal 30 makes (401) a request to the central server for program information 37. This request travels through the interception entity 35. The interception entity 35 does not have a reference for this request and stores it (501) in its database 50. This request has not yet been received by another receiver (after a search (402) in a storage database 39 for storing queries and responses). The central server extracts (403) the information from the database, formats the response and stores it in the server (404) with a maximum duration of validity and sends it back (405) to the receiver 30. The response travels in transit through the intercepting entity 35 which sees that this is a response to the previous query request and stores it (502) in its database 50.

The intercepting entity 35 then receives (406) the same synthesis query request from the receiver 31. It finds (503) the response which is already ready and this response is immediately transmitted (408) to the receiver 31 without the request being transmitted to the central server 37.

In this embodiment of the invention, among the synthesis XML query requests which are sent back to the sender entity sending the initial request, the intermediate apparatus (the intercepting entity in this embodiment) recognizes these queries (for example by extracting the useful part of the first commentary in the header of the XML request) and stores this beginning of a request to be able to compare it with the already received queries, and immediately return the response to the receiver if the same request has already been received and if a valid response is still available.

If not, the synthesis request continues its path to the central server. In return, the local intermediate apparatus (the intercepting entity in this embodiment) recognizes a response to a previous XML request with a shortened request, by analysis of the first comment without XML response header. It extracts the shortened XML request, searches in a table with several elements (substantially identical with that of the central server) for the XML request and records the response for its possible future needs.

The intermediate apparatus also records the date of expiry of the response which is situated in the next commentary in its table of available responses.

Since this approach does not question the existing syntax of the queries being exploited, it can be made general and applicable to all the SOAP queries, not only those defined by “TV_Anytime” but also all those that could be defined in any other protocol of SOAP queries in the XML format.

### 4. Modification of the XML Format of the Request

In this embodiment, we present an implementation of the synthesizing of queries in the form of a modification of an “xsd” scheme.

According to the same principle as in the previous embodiment, a synthesis query request is inserted into the expanded query request. However, instead of being inserted in the form of a commentary, synthesis query request is inserted in the form on an XML element which comprises the attributes that enable the synthesizing.

Thus, at the start of the usual expanded query request, a new XML element is added:

```
    <?xml version=“1.0” encoding=“UTF-8”?>
    <shortcut fld1=”a23” fld2=”124” param1=”titanic”/>
    <get_Data xmlns=urn:tva:transport:2005 ...>
      <QueryConstraints>
        <BinaryPredicate fieldID=“tvaf:Title”
fieldValue=“Titanic” test=“contains”/>
      </QueryConstraints>
      <ReguestedTables>
        <Table type=“ProgramInformationTable”>
          <SortCriteria fieldID=“tvaf:CRID” order=“ascending”/>
        </Table>
      </RequestedTables>
    </get_Data>
```

Within this XML request, the synthesis query request is the following:

<shortcut fld1=”a23” fld2=”124” param1=”titanic”/>

Thus, in this embodiment of the invention, the synthesis query request can be included in the XML tree, and this can make it possible in certain embodiments of the invention to obtain a certain degree of flexibility in the processing or again it provides for checking the consistency of the queries.

### 5. Other Optional Characteristics and Advantages

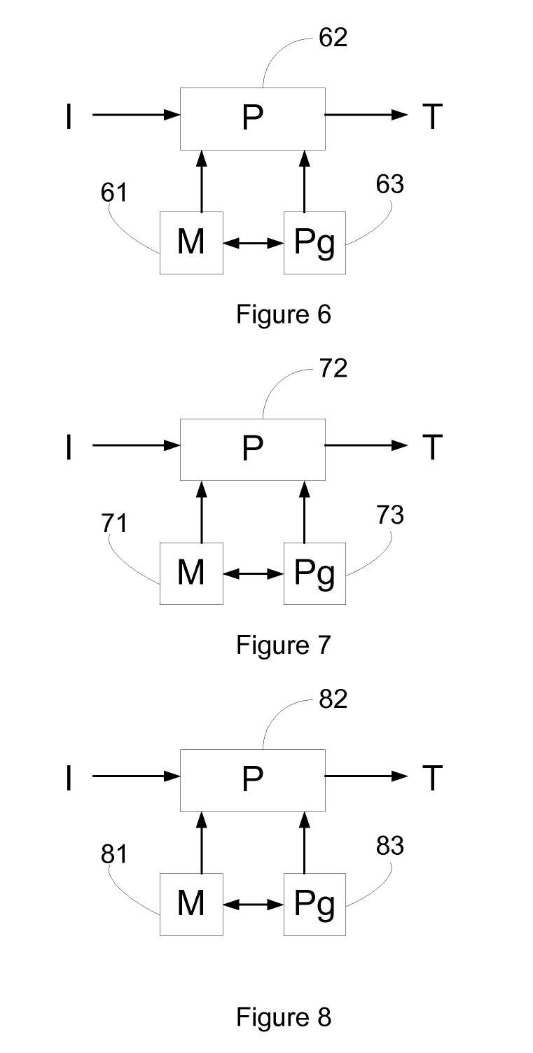

Referring to FIG. 6, an embodiment is presented of a sender entity according to the invention.

Such an entity has a memory 61 constituted by a buffer memory, a processing unit 62 equipped for example with a microprocessor μP and driven by a computer program 63 implementing the processing method of an embodiment of the invention.

At initialization, the instructions of the code of the computer program 63 are for example loaded into a RAM and then executed by the processor of the processing unit 62. At input, the processing unit 62 receives at least one piece of information I to be transmitted (such as, for example, a synthesis query request). The microprocessor of the processing unit 62 implements the steps of the method described here above, according to the instructions of the computer program 63, to deliver a piece of processed information T (such as a synthesis query request). To this end, the sender unit comprises, in addition to the buffer memory 61, means to search for and build synthesis query requests, enabling especially the execution of the method according to an embodiment of the invention. These means are driven by the microprocessor of the processing unit 62.

Referring to FIG. 7, an embodiment is presented of an intercepting entity for implementing the processing method according to an embodiment of the invention.

Such an entity has a memory 71 constituted by a buffer memory, a processing unit 72 equipped for example with a microprocessor μP and driven by a computer program 73 implementing the processing method of an embodiment of the invention.

At initialization, the instructions of the code of the computer program 73 are for example loaded into a RAM and then executed by the processor of the processing unit 72. At input, the processing unit 72 receives at least one piece of information I to be transmitted (such as, for example, a synthesis query request or a response to such a request). The microprocessor of the processing unit 72 implements the steps of the method described here above, according to the instructions of the computer program 73, to deliver a piece of processed information T (such as a response). To this end, the sender unit comprises, in addition to the buffer memory 71, means for routing queries and responses and information-processing means, enabling especially the execution of the method according to an embodiment of the invention. These means are driven by the microprocessor of the processing unit 72.

Referring to FIG. 8, an embodiment is presented of a receiving entity for implementing the processing method according to an embodiment of the invention.

Such an entity has a memory 81 constituted by a buffer memory, a processing unit 82 equipped for example with a microprocessor μP and driven by a computer program 83 implementing the processing method of an embodiment of the invention.

At initialization, the instructions of the code of the computer program 83 are for example loaded into a RAM and then executed by the processor of the processing unit 82. At input, the processing unit 82 receives at least one piece of information I, such as synthesis query requests, to be transmitted. The microprocessor of the processing unit 82 implements the steps of the method described here above, according to the instructions of the computer program 83, to deliver a piece of processed information T, such as responses to the synthesis query requests. To this end, the sender unit comprises, in addition to the buffer memory 81, means for formulating queries and responses and information-processing means, enabling especially the execution of the method according to an embodiment of the invention. These means are driven by the microprocessor of the processing unit 82.

Although the present disclosure has been described with reference to one or more examples, workers skilled in the art will recognize that changes may be made in form and detail without departing from the scope of the disclosure and/or the appended claims.

1. A method for generating a query request designed to be transmitted to at least one receiving entity of a communications network, wherein the method comprises:
receiving a pre-formulated, expanded query request;
selecting a synthesis form adapted to said expanded query request from amongst a set of pre-established synthesis forms; and
building a synthesis query request from said selected synthesis form, said synthesis query request being designed to be transmitted to the receiving entity.

2. The method for generating according to claim 1, wherein said synthesis query request is encapsulated in said expanded query request prior to the transmission of said synthesis query request.

3. The method for generating according to claim 1, wherein said synthesis query request is built out of said selected synthesis form and at least one query parameter specified in said expanded query request.

4. A method for processing a synthesis query request built out of a synthesis form corresponding to an expanded query request, wherein the method comprises:
searching, from said synthesis query request, for a response to said synthesis query request from amongst a set of available responses associated with query requests.

5. The method for processing according to claim 4, wherein the method comprises, when said request has not been found from the synthesis request from amongst the set of available responses:
building said response; and
storing said response in said set of available responses.

6. The method for processing according to claim 5, wherein the method comprises, subsequently to said building step:
time-stamping said stored request defining a date of expiry of said response.

7. The method for processing according to claim 4, wherein the method comprises:
when said response has not been found from the synthesis query request amongst said set of available responses, transmitting said synthesis query request to a receiving entity.

8. The method for processing according to claim 7, wherein the method comprises:
receiving said response to said synthesis query request, coming from said receiving entity; and
storing said response to said query request in said set of available responses.

9. A sender entity sending a query request designed to be transmitted to at least one receiving entity of a communications network, wherein the sender entity comprises:
means for receiving a pre-formulated, expanded query request;
means for selecting a synthesis form adapted to said expanded query request from amongst a set of pre-established synthesis forms; and
means for building a synthesis query request from said selected synthesis form, said synthesis query request being designed to be transmitted to the receiving entity.

10. A receiving entity for receiving a synthesis query request built out of a synthesis form corresponding to an expanded query request, wherein the receiving entity comprises:
means for searching, from said synthesis query request, for a response to said synthesis query request from amongst a set of available responses associated with query requests;
means for building said response; and
means for storing said response in said set of available responses.

11. An intercepting entity for intercepting a synthesis query request built out of a synthesis form corresponding to an expanded query request, wherein the intercepting entity comprises:
means for searching, from said synthesis query request, for a response to said synthesis query request from amongst a set of available responses associated with query requests;
means for transmitting the synthesis query request to a receiving entity;
means for receiving said response to said synthesis query request, coming from said receiving entity; and
means for storing said response to said query request in said set of available responses.

12. A processing system comprising:
a sending entity sending a synthesis query request designed to be transmitted to at least one receiving entity of a communications network, comprising:
means for receiving a pre-formulated, expanded query request;
means for selecting a synthesis form adapted to said expanded query request from amongst a set of pre-established synthesis forms; and
means for building a synthesis query request from said selected synthesis form, said synthesis query request being designed to be transmitted to the receiving entity; and
a receiving entity for receiving the synthesis query request built out of a synthesis form corresponding to the expanded query request, comprising:
means for searching, from said synthesis query request, for a response to said synthesis query request from amongst a set of available responses associated with query requests;
means for building said response; and
means for storing said response in said set of available responses.

13. A processing system according to claim 12, wherein the system furthermore comprises:
at least one intercepting entity for intercepting the synthesis query request built out of a synthesis form corresponding to the expanded query request, comprising:
means of searching, from said synthesis query request, for a response to said synthesis query request from amongst a set of available responses associated with query requests;
means for transmitting the synthesis query request to the receiving entity;
means for receiving said response to said synthesis query request, coming from said receiving entity; and
means for storing said response to said query request in said set of available responses.

14. A computer software product recorded on a computer-readable carrier and executable by a microprocessor, wherein the product comprises program code instructions for executing a method for generating a query request designed to be transmitted to at least one receiving entity of a communications network, wherein the method comprises:
receiving a pre-formulated, expanded query request;
selecting a synthesis form adapted to said expanded query request from amongst a set of pre-established synthesis forms; and
building a synthesis query request from said selected synthesis form, said synthesis query request being designed to be transmitted to the receiving entity.

15. A computer software product recorded on a computer-readable carrier and executable by a microprocessor, wherein the product comprises program code instructions for executing a method for processing a synthesis query request built out of a synthesis form corresponding to an expanded query request, wherein the method comprises:
searching, from said synthesis query request, for a response to said synthesis query request from amongst a set of available responses associated with query requests.
